(19) United States
(12) Patent Application Publication
(10) Pub. No.: US 2017/0269441 A1
(43) Pub. Date: Sep. 21, 2017

(54) LIQUID-CRYSTAL DISPLAY

(71) Applicant: Sharp Kabushiki Kaisha, Osaka (JP)

(72) Inventors: Mitsuhiro MURATA, Osaka (JP); Yosuke IWATA, Osaka (JP); Satoshi MATSUMURA, Osaka (JP); Hidefumi YOSHIDA, Osaka (JP)

(73) Assignee: Sharp Kabushiki Kaisha, Osaka (JP)

(21) Appl. No.: 15/506,580

(22) PCT Filed: Aug. 19, 2015
(86) PCT No.: PCT/JP2015/073183

§ 371 Date: Feb. 24, 2017

(30) Foreign Application Priority Data
Aug. 25, 2014 (JP) 2014-170586

(51) Int. Cl. G02F 1/1343; G02F 1/1368

(52) U.S. Cl. CPC G02F 1/134363; G02F 1/13439; G02F 1/1368; G02F 2201/123; G02F 2001/134372

(57) ABSTRACT

The present invention provides a liquid crystal display device that can improve the response speed from OFF state to ON state. The present invention includes a first substrate, a second substrate, a horizontal-alignment type liquid crystal layer between the first and second substrates, and pixels. The first substrate includes a planar first opposite electrode, a plurality of first pixel electrodes each having a linear shape and arranged parallel to one another in the pixels, and a first insulating layer between the first

### TECHNICAL FIELD

The present invention relates to a liquid crystal display device. More specifically, the present invention relates to a liquid crystal display device suitable for a horizontal alignment mode liquid crystal display device.

### BACKGROUND ART

Liquid crystal display devices have undergone rapid development due to certain benefits, such as being lightweight, thin, and having low power consumption. In recent years, FFS (fringe field switching) mode has become well-known as a liquid crystal mode in liquid crystal display devices that are widely used in portable electronic devices such as smartphones, tablet PCs, and the like.

FFS mode liquid crystal display devices normally include: a substrate having a two-layer electrode structure; a substrate disposed so as to face the aforementioned substrate; and a horizontal-alignment type liquid crystal layer sandwiched between the two substrates. The two-layer electrode structure includes: an upper electrode and a lower electrode formed from transparent conductive materials such as ITO (indium tin oxide) and IZO (indium zinc oxide); and an insulating layer sandwiched between these two electrode layers. A fringe electric field is then generated between the upper electrode and the lower electrode, and the liquid crystal layer is driven via this fringe electric field. One of either the top layer electrode or bottom layer electrode functions as the pixel electrode, and the other functions as the opposite electrode (common electrode).

Research has also been conducted regarding liquid crystal display devices that use other types of liquid crystal modes. Patent Document 1, for example, discloses a liquid crystal display device in which a liquid crystal layer formed of liquid crystal having a positive dielectric anisotropy is sandwiched between a pair of substrates disposed so as to face each other; a pixel electrode and a common electrode, which apply a vertical electric field to the liquid crystal layer, are respectively provided on an element substrate and an opposite substrate; and a comb-shaped electrode, which applies a horizontal electric field to the liquid crystal layer between the comb-shaped electrode and the pixel electrode, is provided above the pixel electrode on the element substrate with an insulating film therebetween.

In addition, Patent Document 2, for example, discloses a liquid crystal display device that has a color filter substrate and an array substrate on which thin film transistors have been provided at respective intersections of signal lines and scan lines arranged in a matrix. This liquid crystal display device has protrusions and recesses in a planarizing film on the array substrate side.

### RELATED ART DOCUMENTS

### Patent Document

Patent Document 1: Japanese Patent No. 3900859
Patent Document 2: Japanese Patent Application Laid-Open Publication No. 2009-86576

### SUMMARY OF THE INVENTION

### Problems to be Solved by the Invention

Transmittance is improved if negative-type liquid crystal is used as the liquid crystal material during FFS mode. However, if negative-type liquid crystal for FFS mode is used, the response speed from OFF state to ON state is slower than if positive-type liquid crystal were used. This is believed to be due to the greater viscosity of negative-type liquid crystal over positive-type liquid crystal, with the viscosity of the negative-type liquid crystal affecting the response from OFF state to ON state.

In the present specification, OFF state refers to a state in which the pixel electrode and opposite electrode are set to the same potential, and ON state refers to a state in which a voltage that is greater than the threshold is being applied between the pixel electrode and opposite electrode.

Patent Document 1 discloses a liquid crystal display device capable of improving response speed, and the response speed from ON state to OFF state is indeed improved, but the response speed from OFF state to ON state is not.

Patent Document 2 describes that providing a protrusion and recess in a planarizing film on the array substrate side can confer high-speed response characteristics, but similar to above this technology does not achieve sufficient response speed when a high-viscosity liquid crystal material is used, and thus there is room for further improvement in response characteristics for the liquid crystal display device of Patent Document 2.

The present invention was made in view of the above-mentioned situation and aims at providing a liquid crystal display device that can improve response speed from OFF state to ON state.

### Means for Solving the Problems

One aspect of the present invention may be a liquid crystal display device, including:

a first substrate; a second substrate facing the first substrate; a horizontal orientation-type liquid crystal layer disposed between the first substrate and the second substrate and containing liquid crystal molecules; and pixels,

wherein the first substrate includes a first opposite electrode that is planar-shaped, a plurality of first pixel electrodes that are linear and disposed parallel to one another in each of the pixels, and a first insulating layer between the first opposite electrode and the plurality of first pixel electrodes,

wherein the second substrate includes a second opposite electrode that is planar-shaped facing the first opposite electrode, a plurality of second pixel electrodes provided corresponding to the plurality of first pixel electrodes in each of the pixels, and a second insulating layer between the second opposite electrode and the plurality of second pixel electrodes,

wherein the plurality of second pixel electrodes are respectively disposed in parallel to the corresponding first pixel electrodes, and

wherein an orientation of the liquid crystal molecules is changed by applying a voltage between the respective first pixel electrodes and the first opposite electrode and applying a voltage between the respective second pixel electrodes and the second opposite electrode.

Hereafter, such a liquid crystal display device is referred to as a liquid crystal display device of the present invention.

Two pixel electrodes being “parallel to each other” (including cases in which two first pixel electrodes, two second pixel electrodes, and one first pixel electrode and one second pixel electrode are parallel to each other) means, more specifically, that the angle formed in the extension direction (lengthwise direction) of the two pixel electrodes is 0° to 1°. The maximum is preferably 0.5° or less, and more preferably 0.2° or less. If the formed angle deviates by 1° or more, there is a risk that the contrast will markedly drop.

Descriptions of preferred embodiments of a liquid crystal display device of the present invention will be provided below. The preferred embodiments described below may be appropriately combined, and an embodiment in which two or more of the preferred embodiments described below are combined is also considered to be a preferred embodiment.

The liquid crystal molecules may have a negative dielectric anisotropy.

In the liquid crystal display device of the present invention, at least one of the plurality of first pixel electrodes, and the second pixel electrode corresponding thereto, may be driven at a different timing than the other first and second pixel electrodes.

The plurality of first pixel electrodes may include three first pixel electrodes that are adjacent to one another; the plurality of second pixel electrodes may include three second pixel electrodes corresponding to the three first pixel electrodes; and, in the liquid crystal display device of the present invention, among the three first pixel electrodes, the first pixel electrode in the center, and the second pixel electrode corresponding thereto, may be driven at a delayed timing compared to the other first and second pixel electrodes.

The first substrate may include a plurality of first switching devices provided corresponding to the plurality of first pixel electrodes; the plurality of first switching devices may respectively connect to the corresponding first pixel electrodes; the second substrate may include a plurality of second switching devices provided corresponding to the plurality of second pixel electrodes; and the plurality of second switching devices may respectively connect to the corresponding second pixel electrodes.

### Effects of the Invention

The present invention makes it possible to realize a liquid crystal display device that can improve the response speed from OFF state to ON state.

### BRIEF DESCRIPTION OF THE DRAWINGS

FIG. 1 is a schematic plan view of a sub-pixel in a liquid crystal display device of Embodiment 1.

FIG. 2 is a schematic cross-sectional view of the liquid crystal display device of Embodiment 1, and corresponds to a cross-section along a line A-B in FIG. 1.

FIG. 3 is a schematic diagram of a circuit configuration of an array substrate in the liquid crystal display device of Embodiment 1.

FIG. 4 is a schematic diagram of a circuit configuration of an opposite substrate in the liquid crystal display device of Embodiment 1.

FIG. 5 is a schematic plan view of a sub-pixel in a liquid crystal display device of Comparative Example 1.

FIG. 6 is a schematic cross-sectional view of the liquid crystal display device of Embodiment 1, and corresponds to a cross-section along a line C-D in FIG. 5.

FIG. 7 is a schematic cross-sectional view of a model used in Working Example 1.

FIG. 8 shows a timing chart of signals applied to the pixel electrode in the respective working examples and comparative examples.

FIG. 9 shows electric field distribution and the liquid crystal director of Working Example 1 in the ON state.

FIG. 10 is a schematic cross-sectional view of a model used in Comparative Example 1.

FIG. 11 shows electric field distribution and the liquid crystal director of Comparative Example 1 in the ON state.

FIG. 12 is a graph that illustrates changes in the transmittance ratios of Working Examples 1 to 5 and Comparative Examples 1 to 2.

FIG. 13 is a graph that illustrates changes in the transmittance ratios of Working Examples 1 to 5 and Comparative Examples 1 to 2, and FIG. 13 expands a portion of FIG. 12 to make it easier to identify response characteristics during onset.

### DETAILED DESCRIPTION OF EMBODIMENTS

Below, embodiments and working examples of the present invention will be explained with reference to figures, but the present invention is not limited to these embodiments and working examples. In addition, the configurations in the respective embodiments and working examples described below may be appropriately combined or changed within a scope that does not depart from the gist of the present invention. In the respective drawings, members exhibiting the same functions are given the same reference characters.

### Embodiment 1

A liquid crystal display device of the present embodiment is an active matrix liquid crystal display device using a lateral electric field scheme and having a display area (the screen) where images are displayed, and the display area is constituted by a plurality of pixels arrayed in a matrix pattern with each of the pixels themselves being made of a plurality (normally 3-6) of sub-pixels of differing colors.

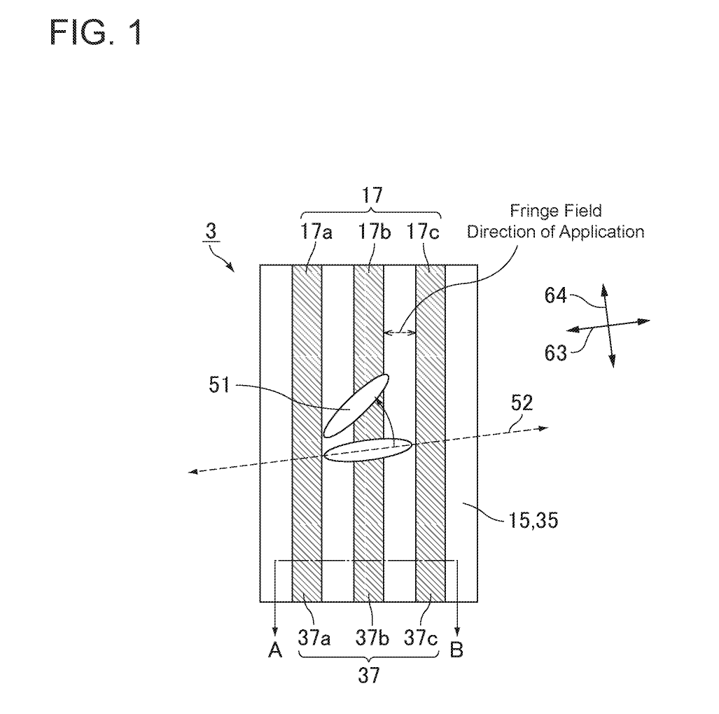

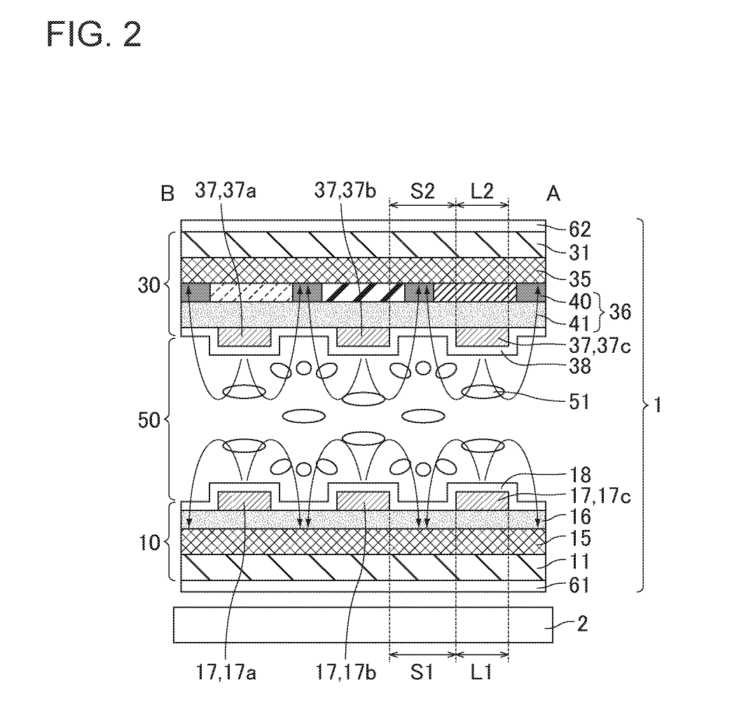

FIG. 1 is a schematic plan view of a sub-pixel in a liquid crystal display device of Embodiment 1. FIG. 2 is a schematic cross-sectional view of the liquid crystal display device of Embodiment 1, and corresponds to a cross-section along a line A-B in FIG. 1.

As shown in FIG. 2, the liquid crystal display device of the present embodiment includes a liquid crystal panel 1, a backlight unit 2 provided behind the liquid crystal panel 1, and a controller (not shown) that drives and controls the backlight unit 2 and liquid crystal panel 1.

The liquid crystal panel 1 includes an array substrate (active matrix substrate) 10 corresponding to the first substrate described above, an opposite substrate 30 corresponding to the second substrate described above and facing the array substrate 10, a horizontal alignment liquid crystal layer 50 interposed between these substrates, and a pair of polarizing plates 61 and 62 respectively provided on the sides of the substrates 10 and 30 opposite to the liquid crystal layer 50. The substrates 10 and 30 are respectively provided on the back side and the viewer side of the liquid crystal display device of the present embodiment. The polarizing plates 61 and 62 are disposed in a crossed Nicols state.

The substrates 10 and 30 are bonded together via a sealing material (not shown) provided so as to surround the display area. The substrates 10 and 30 also face each other through spacers (not shown) such as column-shaped spacers. The liquid crystal layer 50 is then formed as an optical modulation layer by sealing liquid crystal material in a gap between the substrates 10 and 30.

As shown in FIGS. 1 and 2, the array substrate 10 includes a colorless transparent first insulating substrate 11 such as a glass substrate or plastic substrate, and on the liquid crystal layer 50 side of the first insulating substrate 11 a planar first opposite electrode 15, a first insulating layer 16 on the first opposite electrode 15, a plurality of first pixel electrodes 17 provided in the respective sub-pixels 3 on the first insulating layer 16, and a first horizontal alignment film 18 covering the first pixel electrodes 17 are formed. The first horizontal alignment film 18 is seamlessly formed so as to cover at least the entire display area.

The first opposite electrode 15 is formed to cover the display area except where the first contact hole (described later) is formed and is shared by all pixels, or namely all of the sub-pixels 3. The first opposite electrode 15 does not necessarily need to be completely flat.

The first pixel electrodes 17 have a comb-tooth shape and are arranged next to one another in the direction perpendicular to the extension direction thereof (lengthwise direction). The first pixel electrodes 17 are parallel to one another, and each of the first pixel electrodes 17 has a linear shape along the vertical direction, for example. Each of the first pixel electrodes 17 overlaps the first opposite electrode 15 via the first insulating layer 16, and the first opposite electrode 15 and each of the first pixel electrodes 17 are electrically insulated from each other by the first insulating layer 16. As the first pixel electrode 17, three pixel electrodes 17a, 17b, and 17c are provided for each sub-pixel 3, for example.

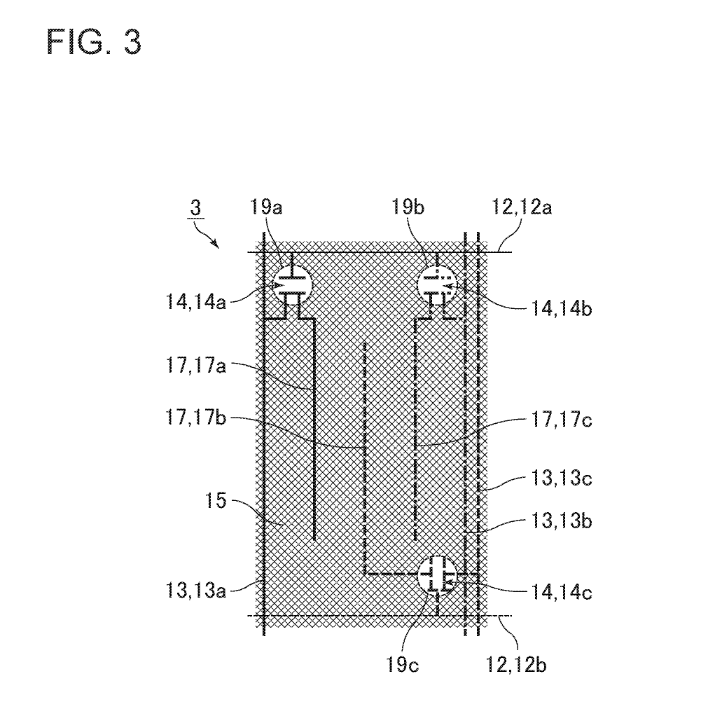

FIG. 3 is a schematic diagram of a circuit configuration of an array substrate in the liquid crystal display device of Embodiment 1.

As shown in FIG. 3, the array substrate 10 further includes a plurality of first gate bus lines 12 parallel to one another between the first insulating substrate 11 and first opposite electrode 15, a plurality of first source bus lines 13 intersecting (e.g., orthogonal to) the first gate bus lines 12, a plurality of first thin film transistors (TFTs) 14, which are switching devices, provided in each sub-pixel 3, and a first interlayer insulating film (not shown). The first opposite electrode 15 is provided on the first interlayer insulating film.

As the first gate bus line 12, two gate bus lines 12a and 12b are provided for each sub-pixel group made of the same row of sub-pixels 3 (the sub-pixels 3 lined up horizontally). As the first source bus line 13, the same number of source bus lines as the number of first pixel electrodes 17 per each sub-pixel 3, such as three source bus lines 13a, 13b, and 13c, are provided for each sub-pixel group made of the same row of sub-pixels 3 (the sub-pixels 3 aligned in the vertical direction). As the first TFT 14, the same number of TFTs as the number of first pixel electrodes 17 per each sub-pixel 3, such as three TFTs 14a, 14b, and 14c, are provided for each sub-pixel 3.

The TFT 14a is provided near the intersection of the gate bus line 12a and source bus line 13a, the TFT 14b is provided near the intersection of the gate bus line 12a and source bus line 13b, and the TFT 14c is provided near the intersection of the gate bus line 12b and source bus line 13c, with the gates of the TFTs 14a and 14b electrically connecting to the gate bus line 12a and the gate of the TFT 14c electrically connecting to the gate bus line 12b. The sources of the TFTs 14a, 14b, and 14c respectively electrically connect to the source bus lines 13a, 13b, and 13c, and the drains of the TFTs 14a, 14b, and 14c respectively electrically connect to the pixel electrodes 17a, 17c, and 17b through the first contact holes 19a, 19b, and 19c. In this manner, the pixel electrodes 17a, 17b, and 17c are respectively driven by the TFTs 14a, 14c, and 14b, and controlled independently of one another.

The first source bus line 13 connects to a first source driver (not shown) outside of the display area, and the first gate bus line 12 connects to a first gate driver (not shown) outside of the display area. Scan signals are applied at prescribed timings from the first gate driver to the respective first gate bus lines 12 via a line-sequential scheme.

The first TFT connected to the first gate bus line to which the scan signal has been applied has a channel generated therein during application of the scan signal, and during this time signals corresponding to display data (gradation) are applied from the first source bus line connected to the first TFT to the first pixel electrode connected to the first TFT through the first TFT.

The timing at which the first pixel electrodes 17 of the same sub-pixel 3 are driven (the timing at which signals are applied to those first pixel electrodes 17) has no particular limitations as long as the timing is within 1 frame, and can be set as appropriate.

Meanwhile, an unvarying common signal (direct current signal or alternating current signal, such as a 0V direct current signal) is applied to the first opposite electrode 15 in accordance with the display data (gradation), and the first opposite electrode 15 functions as a so-called common electrode.

The opposite substrate 30 has the same circuit configuration as the array substrate 10. In other words, as shown in FIGS. 1 and 2, the opposite substrate 30 includes a colorless transparent second insulating substrate 31 such as a glass substrate or plastic substrate, and on the liquid crystal layer 50 side of the second insulating substrate 31 a planar second opposite electrode 35, a second insulating layer 36 on the second opposite electrode 35, a plurality of second pixel electrodes 37 provided in the respective sub-pixels 3 on the second insulating layer 36, and a second horizontal alignment film 38 covering the second pixel electrodes 37 are formed. The second horizontal alignment film 38 is seamlessly formed so as to cover at least the entire display area. A color filter 40 is provided as the second insulating layer 36.

The second opposite electrode 35 is formed to cover the display area except where the second contact hole (described later) is formed and is shared by all pixels, or namely all of the sub-pixels 3. The second opposite electrode 35 does not necessarily need to be completely flat.

The second pixel electrodes 37 have a comb-tooth shape and are arranged next to one another in the direction perpendicular to the extension direction thereof (lengthwise direction). The second pixel electrodes 37 are parallel to one another, and each of the second pixel electrodes 37 has a linear shape along the vertical direction, for example. Each of the second pixel electrodes 37 overlaps the second opposite electrode 35 via the second insulating layer 36, and the second opposite electrode 35 and each of the second pixel electrodes 37 are electrically insulated from each other by the second insulating layer 36. As the second pixel electrode 37, the same number as the number of first pixel electrodes 17, such as three pixel electrodes 37a, 37b, and 37c, are provided for each sub-pixel 3, for example.

The second pixel electrodes 37 are provided corresponding to the first pixel electrodes 17, and each of the second pixel electrodes 37 is arranged in parallel to the corresponding first pixel electrode 17 and facing the corresponding first pixel electrode 17. When viewing the liquid crystal panel 1 in a plan view, each of the second pixel electrodes 37 overlaps the corresponding first pixel electrode 17, but does not overlap the other first pixel electrodes 17.

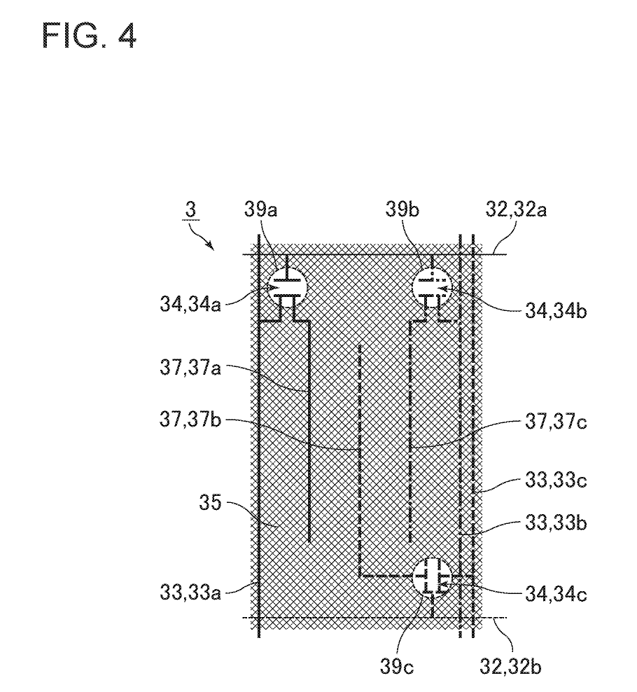

FIG. 4 is a schematic diagram of a circuit configuration of an opposite substrate in the liquid crystal display device of Embodiment 1.

As shown in FIG. 4, the opposite substrate 30 further includes a plurality of second gate bus lines 32 parallel to one another between the second insulating substrate 31 and second opposite electrode 35, a plurality of second source bus lines 33 intersecting (e.g., orthogonal to) the second gate bus lines 32, a plurality of second thin film transistors (TFTs) 34, which are switching devices, provided in each sub-pixel 3, and a second interlayer insulating film (not shown). The second opposite electrode 35 is provided on the second interlayer insulating film.

As the second gate bus line 32, two gate bus lines 32a and 32b are provided for each sub-pixel group made of the same row of sub-pixels 3 (the sub-pixels 3 lined up horizontally). As the second source bus line 33, the same number of source bus lines as the number of second pixel electrodes 37 per each sub-pixel 3, such as three source bus lines 33a, 33b, and 33c, are provided for each sub-pixel group made of the same row of sub-pixels 3 (the sub-pixels 3 aligned in the vertical direction). As the second TFT 34, the same number of TFTs as the number of second pixel electrodes 37 per each sub-pixel 3, such as three TFTs 34a, 34b, and 34c, are provided for each sub-pixel 3.

The TFT 34a is provided near the intersection of the gate bus line 32a and source bus line 33a, the TFT 34b is provided near the intersection of the gate bus line 32a and source bus line 33b, and the TFT 34c is provided near the intersection of the gate bus line 32b and source bus line 33c, with the gates of the TFTs 34a and 34b electrically connecting to the gate bus line 32a and the gate of the TFT 34c electrically connecting to the gate bus line 32b. The sources of the TFTs 34a, 34b, and 34c respectively electrically connect to the source bus lines 33a, 33b, and 33c, and the drains of the TFTs 34a, 34b, and 34c respectively electrically connect to the pixel electrodes 37a, 37c, and 37b through the second contact holes 39a, 39b, and 39c. In this manner, the pixel electrodes 37a, 37b, and 37c are respectively driven by the TFTs 34a, 34c, and 34b, and controlled independently of one another.

The second source bus line 33 connects to a second source driver (not shown) outside of the display area, and the second gate bus line 32 connects to a second gate driver (not shown) outside of the display area. Scan signals are applied at prescribed timings from the second gate driver to the respective second gate bus lines 32 via a line-sequential scheme.

The second TFT connected to the second gate bus line to which the scan signal has been applied has a channel generated therein during application of the scan signal, and during this time signals corresponding to display data (gradation) are applied from the second source bus line connected to the second TFT to the second pixel electrode connected to the second TFT through the second TFT.

The timing at which the second pixel electrodes 37 of the same sub-pixel 3 are driven (the timing at which signals are applied to those second pixel electrodes 37) has no particular limitations as long as the timing is within 1 frame, and can be set as appropriate, but ordinarily each of the second pixel electrodes 37 are driven at the same timing as the corresponding first pixel electrode 17, and signals are applied to each of the second pixel electrodes 37 at the same timing as the corresponding first pixel electrode 17.

It is preferable that the first and second pixel electrodes 17 and 37 of the same sub-pixel be driven in order of the direction of flow of the liquid crystal. Driving the pixel electrodes vertically corresponding to each other in accordance with the flow of liquid crystal in this manner makes it possible to further increase the response speed from OFF state to ON state.

Meanwhile, an unvarying common signal (direct current signal or alternating current signal, such as a 0V direct current signal) is applied to the second opposite electrode 35 in accordance with the display data (gradation), and the second opposite electrode 35 functions as a so-called common electrode. The first and second opposite electrodes 15 and 35 ordinarily have the same common signal applied thereto.

The liquid crystal layer 50 exhibits a nematic phase and contains at least liquid crystal molecules 51 with a positive or negative dielectric anisotropy (Δ∈). Each of the horizontal alignment films 18 and 38 aligns nearby liquid crystal molecules 51 in a direction substantially parallel to the surface of the film via an alignment regulating force. In the OFF state, or namely in the state in which the first pixel electrodes 17, second pixel electrodes 37, first opposite electrode 15, and second opposite electrode 35 are set to the same potential, the liquid crystal molecules 51 of the entire liquid crystal layer 50 exhibit a parallel alignment (horizontal alignment, homeotropic alignment), and each of the liquid crystal molecules 51 is aligned such that the long axes of the molecules is generally parallel to the surface of each of the substrates 10 and 30.

When the long axis direction of the liquid crystal molecules 51 in a plan view of the liquid crystal panel 1 in the OFF state is defined as an initial alignment direction 52, then the angle formed by the initial alignment direction 52 and the extension direction (lengthwise direction) of the respective pixel electrodes 17 and 37 when the liquid crystal molecules 51 have a negative dielectric anisotropy is preferably within a range of 97°±1°, as shown in FIG. 1, or more preferably within a range of 97°±0.5°, and even more preferably within a range of 97°±0.2°. When the liquid crystal molecules 51 have a positive dielectric anisotropy, the above-mentioned angle is preferably within a range of 7°±1°, or more preferably within a range of 7°±0.5°, and even more preferably within a range of 7°±0.2°. There is a risk of a marked drop in contrast outside of the 97°±1° or 7°±1° range. In FIG. 1, for convenience of explanation, the liquid crystal molecules 51 are shown as arranged above both the first pixel electrode 17 and the second pixel electrode 37, but as shown in FIG. 2 the liquid crystal molecules are actually located inside the liquid crystal layer 50 between the first and second pixel electrodes 17 and 37.

When viewing the liquid crystal panel 1 in a plan view, one transmission axis 63 of the polarizing plates 61 and 62, which are arranged in a crossed Nicols state, is parallel to the initial alignment direction 52, and the other transmission axis 64 is perpendicular to the initial alignment direction 52. Thus, the present embodiment realizes a normally black mode, and in OFF state, the transmittance ratio becomes the lowest possible value, or in other words, a black screen is displayed. In OFF state, the light emitted from the backlight unit 2 is converted to polarized light, such as linearly polarized light, by passing through the polarizing plate 61, and this polarized light passes through the liquid crystal layer 50 with hardly any change in the polarized state, and is then blocked by the polarizing plate 62.

Next, ON state will be explained.

In the ON state, or namely in the state in which a voltage greater than the threshold is applied between the respective first pixel electrodes 17 and first opposite electrode 15 and a voltage greater than the threshold is applied between the respective second pixel electrodes 37 and second opposite electrode 35, a parabolic fringe electric field is generated between the respective first pixel electrodes 17 and first opposite electrode 15, as shown in FIG. 2, and a parabolic fringe electrode field is also generated between the respective second pixel electrodes 37 and second opposite electrode 35, and these fringe fields are applied to the liquid crystal layer 50. Each fringe field is generated in a direction generally perpendicular to the extension direction (lengthwise direction) of the respective pixel electrodes 17 and 37. This results in a change in the orientation of the liquid crystal molecules 51. More specifically, as shown in FIG. 1, if the liquid crystal molecules 51 to which the fringe field has been applied have a negative dielectric anisotropy, then the long axis direction of the molecules rotates away from the direction of the fringe field, and if the molecules have a positive dielectric anisotropy, the long axis direction of the molecules rotates towards the direction of the fringe field. In either case, the long axis direction of the liquid crystal molecules 51 rotates away from the initial alignment direction 52. Therefore, the polarized state of the polarized light such as the linearly polarized light that has entered the liquid crystal layer 50 changes, and at least a portion of the polarized light passes through the polarizing plate 62. In this manner, in the ON state, light emitted from the backlight unit 2 passes through the liquid crystal panel 2.

The intensity of each of the fringe fields is proportional to the voltage applied between the pixel electrode where the fringe field is generated and the opposite electrode opposing this pixel electrode, and the higher the intensity of the fringe field applied to the liquid crystal molecules 51, the greater the rotation of those crystal molecules 51. Thus, the amount of light passing through the liquid crystal panel 1 (the transmittance) can be controlled by appropriately modifying the magnitudes of the voltages applied between the respective first pixel electrodes 17 and first opposite electrode 15, and the magnitudes of the voltages applied between the respective second pixel electrodes 37 and the second opposite electrode 35. Accordingly, controlling the magnitudes of the respective applied voltages in the respective sub-pixels 3 makes it possible to control the transmittance of light from the backlight unit 2 for each sub-pixel 3, thereby allowing the desired image to be displayed in the display area.

As described above, the liquid crystal display device of the present embodiment includes: the array substrate (first substrate) 10; the opposite substrate (second substrate) 30 facing the array substrate 10; the horizontal orientation-type liquid crystal layer 50 disposed between the array substrate 10 and the opposite substrate 30 and containing liquid crystal molecules 51; and sub-pixels 3. The array substrate 10 includes a first opposite electrode 15 that is planar-shaped, a plurality of first pixel electrodes 17 that are linear and disposed parallel to one another in each of the sub-pixels 3, and a first insulating layer 16 between the first opposite electrode 15 and the plurality of first pixel electrodes 17; the opposite substrate 30 includes a second opposite electrode 35 that is planar-shaped facing the first opposite electrode 15, a plurality of second pixel electrodes 37 provided corresponding to the plurality of first pixel electrodes 17 in each of the sub-pixels 3, and a second insulating layer 36 between the second opposite electrode 35 and the plurality of second pixel electrodes 37. The plurality of second pixel electrodes 37 are respectively disposed in parallel to the corresponding first pixel electrodes 17, and an orientation of the liquid crystal molecules 51 is changed by applying a voltage between the respective first pixel electrodes 17 and the first opposite electrode 15 and applying a voltage between the respective second pixel electrodes 37 and the second opposite electrode 35.

As described above, the array substrate 10 includes a first opposite electrode 15 that is planar-shaped, a plurality of first pixel electrodes 17 that are linear and disposed parallel to one another in each of the sub-pixels 3, and a first insulating layer 16 between the first opposite electrode 15 and the plurality of first pixel electrodes 17; the opposite substrate 30 includes a second opposite electrode 35 that is planar-shaped facing the first opposite electrode 15, a plurality of second pixel electrodes 37 provided corresponding to the plurality of first pixel electrodes 17 in each of the sub-pixels 3, and a second insulating layer 36 between the second opposite electrode 35 and the plurality of second pixel electrodes 37. The plurality of second pixel electrodes 37 are respectively disposed in parallel to the corresponding first pixel electrodes 17, and an orientation of the liquid crystal molecules 51 is changed by applying a voltage between the respective first pixel electrodes 17 and the first opposite electrode 15 and applying a voltage between the respective second pixel electrodes 37 and the second opposite electrode 35. Because of the above, the liquid crystal display device of the present embodiment can generate fringe fields between the respective first pixel electrodes 17 and the first opposite electrode 15 (in the vicinity of the array substrate 10), and also generate fringe fields between the respective second pixel electrodes 37 and the second opposite electrode 35 (in the vicinity of the opposite substrate 30). Furthermore, the liquid crystal display device of the present embodiment can change the orientation of the liquid crystal molecules 51 via this pair of upper and low fringe fields. Accordingly, the liquid crystal display device of the present embodiment can more actively drive the liquid crystal molecules 51 and realize a faster response speed from OFF state to ON state than an ordinary FFS liquid crystal display device, which uses only fringe fields near one substrate to drive only the liquid crystal molecules adjacent to that substrate. Furthermore, the liquid crystal display device of the present embodiment can effectively drive the liquid crystal molecules 51 in the entire liquid crystal layer 50 by upper and lower fringe fields, which makes it possible to achieve a higher transmittance than the ordinary FFS liquid crystal display device described above.

In addition, the liquid crystal display device of the present embodiment may be a monochrome liquid crystal display device, and may be configured such that each pixel is not divided into a plurality of sub-pixels 3. In such a case, the members disposed in each sub-pixel 3 described above (e.g., the first and second pixel electrodes 17 and 37, etc.) can be disposed in each pixel and the color filter layer 40 can be omitted.

It is preferable that the liquid crystal molecules 51 have a negative dielectric anisotropy, as this allows a higher light transmittance than a positive dielectric anisotropy. In the present embodiment, upper and lower fringe fields can drive the liquid crystal molecules 51 as described above, and high-speed responses can be achieved even if negative-type liquid crystal is used.

It is preferable that the liquid crystal display device of the present embodiment drive at least one of the plurality of first pixel electrodes 17 and the second pixel electrode corresponding thereto at a different timing from the other first and second pixel electrodes 17 and 37, as this makes it possible to further improve the response speed from OFF state to ON state.

From a similar perspective, it is preferable that the plurality of first pixel electrodes 17 include the adjacent three pixel electrodes (first pixel electrodes) 17a, 17b, and 17c; that the plurality of second pixel electrodes 37 include the three second pixel electrodes 37a, 37b, and 37c corresponding to the three pixel electrodes (first pixel electrodes) 17a, 17b, and 17c; and that the liquid crystal display device of the present embodiment drive the first pixel electrode 17b located in the center among the three first pixel electrodes 17a, 17b, and 17c and the second pixel electrode 37b corresponding thereto at a slower timing than the other first and second pixel electrodes 17a, 17c, 37a, and 37c. The offset (gap) between the timings for driving in this case has no particular limitations as long as the offset is within a single frame and can be set as appropriate.

The array substrate 10 includes a plurality of first TFTs (first switching devices) 14 corresponding to the plurality of first pixel electrodes 17, each of the plurality of first TFTs 14 preferably connecting to the corresponding first pixel electrodes 17, and the opposite substrate 30 includes a plurality of second TFTs (first switching devices) 34 corresponding to the plurality of second pixel electrodes 37, each of the plurality of second TFTs 34 preferably connecting to the corresponding second pixel electrodes 37, thus allowing the timing at which the respective pixel electrodes 17 and 37 are driven to be set as appropriate.

The number of first pixel electrodes 17 per sub-pixel 3 has no particular limitations as long as the number is at least 2, and the number may be set as appropriate while taking into account the size of the sub-pixel 3 and extension direction (lengthwise direction) of the first pixel electrode 17. In a similar manner, the number of second pixel electrodes 37 per sub-pixel 3 has no particular limitations as long as the number is at least 2, and the number may be set as appropriate while taking into account the size of the sub-pixel 3 and extension direction (lengthwise direction) of the second pixel electrode 37.

The extension direction (lengthwise direction) of the respective pixel electrodes 17 and 37 has no particular limitations, but as shown in FIGS. 3 and 4, the respective pixel electrodes 17 and 37 are ordinarily arranged along the respective source bus lines 13 and 33 or along the gate bus lines.

Each gap S1 between the adjacent first pixel electrodes 17 and each gap S2 between the adjacent second pixel electrodes 37 has no particular limitations, but is preferably 3 μm to 8 μm, and more preferably 3 μm to 5 μm. The gaps S1 can be set independently from the other gaps S1 as appropriate, but the gaps S2 are ordinarily set to be substantially the same as the corresponding gaps S1.

The width L1 of each pixel electrode 17 and the width L2 of each second pixel electrode 37 has no particular limitations, but is preferably 2 μm to 5 μm. Each width L1 can be set independently from other widths L1 as appropriate, but each width L2 is ordinarily set to be substantially the same as the corresponding width L1.

In the present specification, a “width of the pixel electrode” refers to a length of the pixel electrode in a direction orthogonal to the extension direction (lengthwise direction) thereof.

The pre-tilt angle of the liquid crystal layer 50 (liquid crystal molecules 51) is preferably 0° to 3°, and more preferably 0° to 2°. If the pre-tilt angle is greater than or equal to 0°, it is possible to use a photoalignment film as the first and second horizontal alignment films 18 and 38. This is due to the fact that the pre-tilt angle of photoalignment films, which have been used in the production of liquid crystal display devices in recent years, is greater than or equal to 0°. If the pre-tilt angle exceeds 2°, there is a chance that the viewing angle characteristics may degrade. It is possible to prevent degradation in the viewing angle characteristics in a diagonal direction by making the pre-tilt angle as small as possible. For the first and second horizontal alignment films 18 and 38, it is also possible to use alignment films that have had a rubbing treatment, and in such a case the pre-tilt angle of the liquid crystal layer 50 is ordinarily greater than 0°. The pre-tilt angle can be measured using an ellipsometric device (trade name: OptiPro) made by Shintech Inc. Furthermore, in an OFF state, the liquid crystal molecules 51 are oriented in a prescribed direction, and the long-axis direction of the liquid crystal molecules 51 in the OFF state is generally aligned with the direction of the alignment treatment (e.g., with the direction of the rubbing).

The specific value for the anisotropy of the liquid crystal molecules 51 has no particular limitations, but is preferably −3 to −5 when negative, and 3 to 8 when positive.

The product of the cell thickness d and birefringence Δn (value with respect to wavelength λ light), or namely the panel retardation, has no particular limitations and can be set as appropriate. In addition, there are no particular restrictions regarding the viscosity of the liquid crystal in the liquid crystal layer 50, and the viscosity can be set as appropriate.

It is possible to use an ordinary backlight unit as the backlight unit 2 and an ordinary control unit as the control unit as appropriate.

A pair of linearly polarizing plates can be used as the polarizing plates 61 and 62. In such a case, the absorption axes of the pair of linearly polarizing plates are substantially orthogonal to one another.

The linearly polarizing plates respectively include a linearly polarizing element. A typical example of a linearly polarizing element is a material in which an anisotropic material such as a dichoric iodine complex or the like is adsorbed and oriented on a polyvinyl alcohol (PVA) film. In order to ensure mechanical strength and resistance to heat and moisture, the respective linearly polarizing plates usually further include a protective film such as a cellulose triacetate (TAC) film that has been laminated onto both surfaces of a PVA film with an adhesive layer interposed therebetween.

In order to further improve the viewing angle characteristics, an optical film, such as a retardation plate, may be provided between the array substrate 10 and the polarizing plate 61 and/or between the opposite substrate 30 and the polarizing plate 62.

There are no particular limitations regarding the materials used for the first and second horizontal alignment films 18 and 38, and alignment film materials used in an ordinary FFS mode can be used, for example. Furthermore, each of the horizontal alignment films 18 and 38 may be an organic alignment film formed using an organic material such as a polyimide or may be an inorganic alignment film formed using an inorganic material such as silicon oxide. There are no particular limitations regarding the method of alignment treatment for the horizontal alignment films 18 and 38, and the alignment treatment may be a rubbing treatment, or may be a photoalignment treatment, for example.

There are no particular limitations regarding the material of the first pixel electrodes 17, first opposite electrode 15, second pixel electrodes 37, and second opposite electrode 35; it is possible to use an ordinary conductive material, e.g., a transparent conductive material such as ITO, IZO, or the like. All of the first pixel electrodes 17 are made from the same conductive film in the same step, and all of the second pixel electrodes 37 are made from the same conductive film in the same step.

There are no particular limitations regarding the material used in the first insulating layer 16, and examples of such a material include: an inorganic insulating material, such as a silicon nitride (SiNx), in which a permittivity c is 3 to 4; and an organic insulating material, such as a photosensitive acrylic resin, a photosensitive polyimide, or the like, in which the permittivity ∈ is 7.

Ordinary materials can be used to form constituting components of the TFT array substrate 10 that are not mentioned above.

The color filter layer 40 includes a plurality of colored layers respectively provided so as to correspond to the sub-pixels 3. The colored layers are used to perform color display and are formed from transparent organic insulating films, such as acrylic resins that contain pigments, or the like, and are mainly formed within the aperture region. This makes color display possible. The respective pixels are formed of three sub-pixels that respectively output R (red), G (green), and B (blue) colored light, for example. There are no particular restrictions regarding the type and number of colors in the sub-pixels 3 forming the respective pixels, and these values may be set as appropriate. In other words, for example, each pixel may be formed of three sub-pixels that are respectively cyan, magenta, and yellow, or each pixel may be formed of four or more sub-pixels (four colors consisting of R, G, B, and Y (yellow), for example).

The color filter layer 40 may further include a black matrix (BM) layer that shields a region between adjacent sub-pixels 3. The BM layer can be formed from a non-transparent metallic film (a chromium film, for example) and/or a non-transparent organic film (an acrylic resin that contains carbon, for example).

In FIG. 2, for convenience of explanation, three color filters with differing colors are shown inside a single sub-pixel, but in practice a color filter of only one color is formed in a single sub-pixel.

As shown in FIG. 2, it is preferable that a transparent overcoat layer 41 be further provided as a second insulating layer 36 between the color filter layer 40 and the second horizontal alignment film 38. By so doing, it is possible to flatten the surface of the opposite substrate 30 on the liquid crystal layer 50 side. There are no particular limitations regarding the material used in the overcoat layer 41, and examples of such a material include an organic insulating material, such as an acrylic resin or a polyimide, that has a permittivity ∈ of 3 to 4, or the like. It is preferable that the thickness of the overcoat layer 41 be greater than 1 to 3 μm. Protrusions may be provided on the surface of the overcoat layer 41, and these protrusions may function as column-shaped spacers. An example of a method for providing protrusions in the overcoat layer 41 is photolithography that utilizes a multitone photomask.

### Comparative Example 1

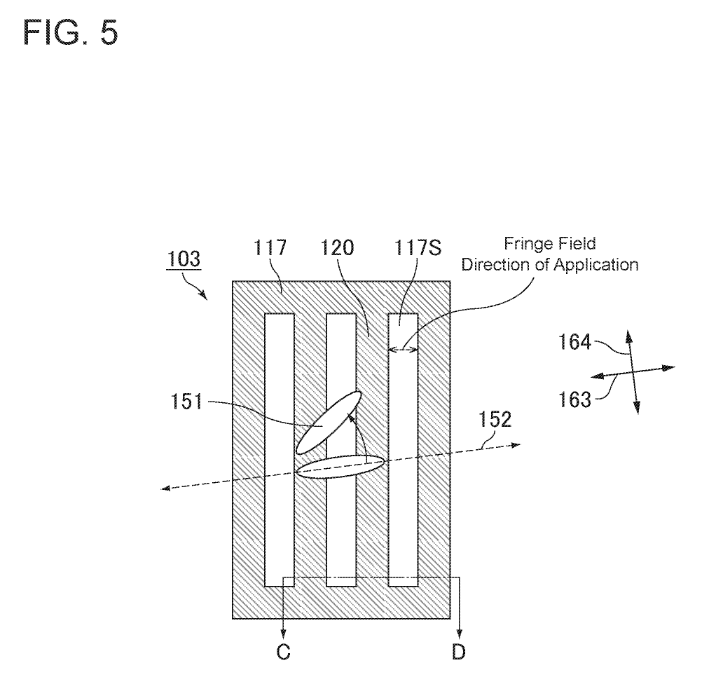

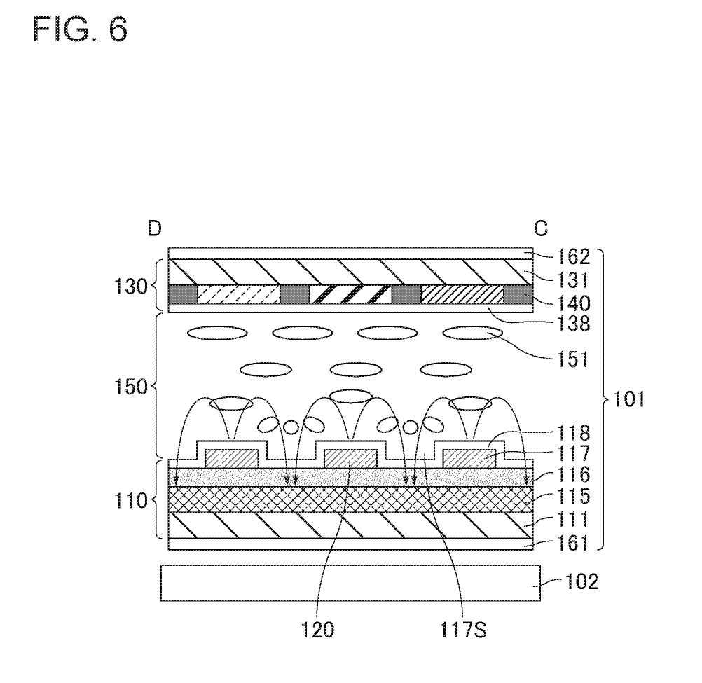

FIG. 5 is a schematic plan view of a sub-pixel in a liquid crystal display device of Comparative Example 1. FIG. 6 is a schematic cross-sectional view of the liquid crystal display device of Comparative Example 1, and corresponds to a cross-section along a line C-D in FIG. 5.

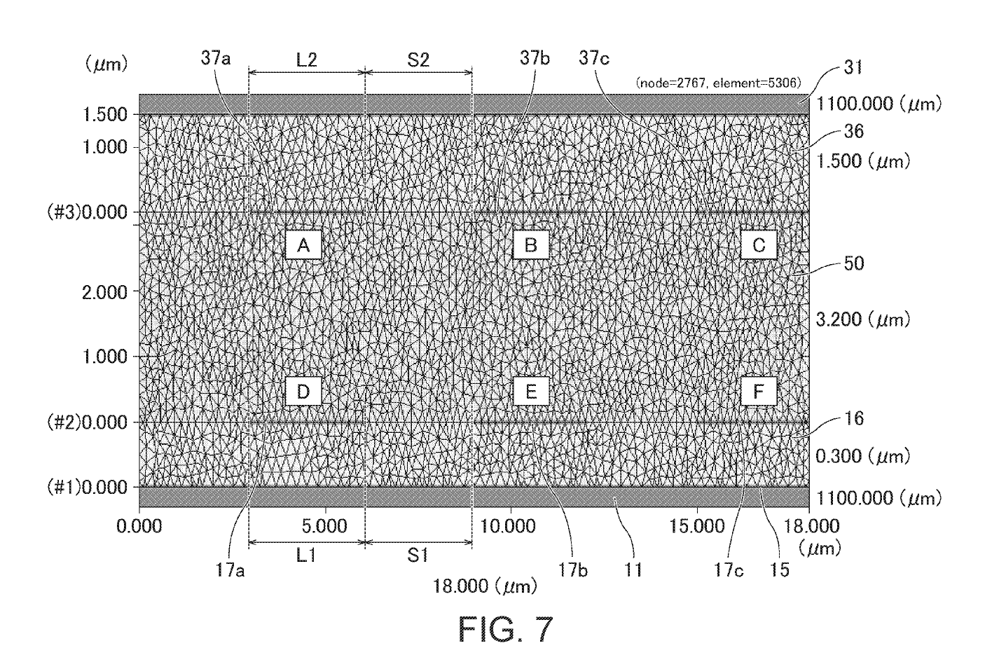

The liquid crystal display device of the present comparative example is an FFS liquid crystal display device, and as shown in FIG. 7, the device includes a liquid crystal panel 101, a backlight unit 102 provided behind the liquid crystal panel 101, and a controller (not shown) that drives and controls the liquid crystal panel 101 and backlight unit 102.

The liquid crystal panel 101 includes an array substrate (active matrix substrate) 110, opposite substrate 130 facing the array substrate 110, a horizontal alignment liquid crystal layer 150 sandwiched between these substrates, and a pair of polarizing plates 161 and 162 respectively disposed on the primary surfaces of the substrates 110 and 130 opposite to the liquid crystal layer 150. The polarizing plates 161 and 162 are disposed in a crossed Nicols state.

The substrates 110 and 130 are bonded together via a sealing material (not shown) provided so as to surround the display area. The substrates 110 and 130 also face each other through spacers (not shown) such as column-shaped spacers. The liquid crystal layer 150 is then formed as an optical modulation layer by sealing liquid crystal material in a gap between the substrates 110 and 130.

As shown in FIGS. 5 and 6, the array substrate 110 includes a colorless transparent first insulating substrate 111 such as a glass substrate or plastic substrate, and on the liquid crystal layer 150 side of the first insulating substrate 111 a planar first opposite electrode 115, a first insulating layer 116 on the first opposite electrode 115, a plurality of first pixel electrodes 117 provided in the respective sub-pixels 103 on the first insulating layer 116, and a first horizontal alignment film 118 covering the first pixel electrodes 117 are formed. The first horizontal alignment film 118 is seamlessly formed so as to cover at least the entire display area.

The pixel electrode 117 has a plurality of slits 117S formed therein and extending in the vertical direction, and the pixel electrode 117 has a plurality of linear portions 120 arranged with gaps therebetween. The pixel electrode 117 may be a comb-shaped pixel.

There are no particular limitations regarding the material used in the first insulating layer 116, and examples of such a material include: an inorganic insulating material, such as a silicon nitride (SiNx), in which a permittivity ∈ is 3 to 4; and an organic insulating material, such as a photosensitive acrylic resin, a photosensitive polyimide, or the like, in which the permittivity ∈ is 7.

As shown in FIGS. 5 and 6, the opposite substrate 130 includes a colorless transparent second insulating substrate 131 such as a glass substrate or plastic substrate, and on the liquid crystal layer 150 side of the second insulating substrate 131 a color filter 140 as the second insulating layer and a second horizontal alignment film 138 covering the color filter layer 140 are formed. The second horizontal alignment film 138 is seamlessly formed so as to cover at least the entire display area.

Furthermore, each of the horizontal alignment films 118 and 138 may be an organic alignment film formed using an organic material such as a polyimide or may be an inorganic alignment film formed using an inorganic material such as silicon oxide. There are no particular restrictions regarding the method of alignment treatment for the horizontal alignment films 118 and 138, and the alignment treatment may be a rubbing treatment, or may be a photoalignment treatment, for example.

The liquid crystal layer 150 exhibits a nematic phase and contains at least liquid crystal molecules 151 with a negative dielectric anisotropy (Δ∈). Each of the horizontal alignment films 118 and 138 aligns nearby liquid crystal molecules 151 in a direction substantially parallel to the surface of the film via an alignment regulating force. In the OFF state, or namely in the state in which the pixel electrodes 117 and opposite electrode 115 are set to the same potential, the liquid crystal molecules 151 of the entire liquid crystal layer 150 exhibit a parallel alignment (horizontal alignment, homeotropic alignment), and each of the liquid crystal molecules 151 is aligned such that the long axes of the molecules is generally parallel to the surface of each of the substrates 110 and 130.

When the long axis direction of the liquid crystal molecules 151 in a plan view of the liquid crystal panel 101 in the OFF state is defined as an initial alignment direction 152, then the angle formed by the initial alignment direction 152 and the extension direction (lengthwise direction) of the respective linear portions 120 of the pixel electrode 117 is within a range of 97°±1.

When viewing the liquid crystal panel 101 in a plan view, one transmission axis 163 of the polarizing plates 161 and 162, which are arranged in a crossed Nicols state, is parallel to the initial alignment direction 152, and the other transmission axis 164 is perpendicular to the initial alignment direction 152. Thus, the present comparative example realizes a normally black mode, and in OFF state, the transmittance ratio becomes the lowest possible value, or in other words, a black screen is displayed.

In the ON state, or namely in the state in which a voltage greater than the threshold is applied between the pixel electrode 117 and opposite electrode 115, a parabolic fringe electric field is generated between the respective linear portions 120 and opposite electrode 115, as shown in FIG. 6, and these fringe fields are applied to the liquid crystal layer 150. Each fringe field is generated in a direction generally perpendicular to the extension direction (lengthwise direction) of the respective linear portions 120. This results in a change in the orientation of the liquid crystal molecules 151. More specifically, as shown in FIG. 5, the liquid crystal molecules 151 to which the fringe field has been applied have the long axis direction thereof rotate away from the direction of the fringe field and away from the initial alignment direction 152. Therefore, the polarized state of the polarized light such as the linearly polarized light that has entered the liquid crystal layer 150 changes, and at least a portion of the polarized light passes through the polarizing plate 162. In this manner, in the ON state the light emitted from the backlight unit 102 passes through the liquid crystal panel 101.

Hereafter, the results of simulations conducted regarding the liquid crystal display device of Embodiment 1 and a comparative example will be explained. In the present specification, the respective simulations were conducted using an LCD-Master 2F manufactured by Shintech Inc.

### Working Example 1

Simulations were conducted regarding the liquid crystal panel having the structure shown in FIGS. 1 and 2. FIG. 7 is a schematic cross-sectional view of a model used in Working Example 1.

The liquid crystal layer 50 was formed using negative-type liquid crystal with a birefringence Δn of 0.1, a dielectric anisotropy Δ∈ of −2.5, and a viscosity of 120 cP. The cell thickness was set to 3.2 μm and the panel retardation Re to 320 nm. The initial alignment of the liquid crystal liquid was set to a parallel alignment under the presumption of horizontal alignment films being arranged on the respective front surfaces of the array substrate and opposite substrate on the liquid crystal layer 50 side. The first opposite electrode 15, first insulating layer 16 on the first opposite electrode 15, and pixel electrodes 17a, 17b, and 17c as the first pixel electrodes on the first insulating layer 16 were arranged on the liquid crystal layer 50 side of the first insulating substrate 11 of the array substrate. The first opposite electrode 15 was seamlessly disposed in a rectangular shape in the entire sub-pixel region. The dielectric constant of the first insulating layer 16 was set to 6.9 and the film thickness to 0.3 μm. The respective pixel electrodes 17a, 17b, and 17c were linear and extended in the vertical direction (the direction perpendicular to the sheet surface of FIG. 5), and the pixel electrodes 17a, 17b, and 17c were arranged parallel to one another. The width L1 of the respective pixel electrodes 17a, 17b, and 17c was set to 3 μm and the respective gaps S1 between the adjacent pixel electrodes were set to 3 μm. The second opposite electrode 35, second insulating layer 36 on the second opposite electrode 35, and pixel electrodes 37a, 37b, and 37c as the second pixel electrodes on the second insulating layer 36 were arranged on the liquid crystal layer 50 side of the second insulating substrate 31 of the opposite substrate. The pixel electrodes 37a, 37b, and 37c were each arranged corresponding to the pixel electrodes 17a, 17b, and 17c. The second opposite electrode 35 was seamlessly disposed in a rectangular shape in the entire sub-pixel region. The dielectric constant of the second insulating layer 36 was set to 3.4 and the film thickness to 1.5 μm. The respective pixel electrodes 37a, 37b, and 37c were linear and extended in the vertical direction (the direction perpendicular to the sheet surface of FIG. 5), and the pixel electrodes 37a, 37b, and 37c were arranged parallel to one another. Each of the pixel electrodes 37a, 37b, and 37c was arranged directly above the corresponding pixel electrodes 17a, 17b, and 17c. The width L2 of the respective pixel electrodes 37a, 37b, and 37c was set to 3 μm and the respective gaps S2 between the adjacent pixel electrodes was set to 3 μm. In this manner, the arrangement and shape of each of the pixel electrodes 37a, 37b, and 37c were made to match the arrangement and shape of the corresponding pixel electrodes 17a, 17b, and 17c. The angle formed by the initial alignment direction and the extension direction of the respective pixel electrodes 17a, 17b, 17c, 37a, 37b, and 37c was set to 97°. A pair of polarizing plates were disposed in a crossed Nicols state, with one transmission axis being disposed parallel to the initial alignment direction and the other transmission axis being disposed orthogonal to the initial alignment direction, with the liquid crystal panel of the present working example being set to a normally black mode.

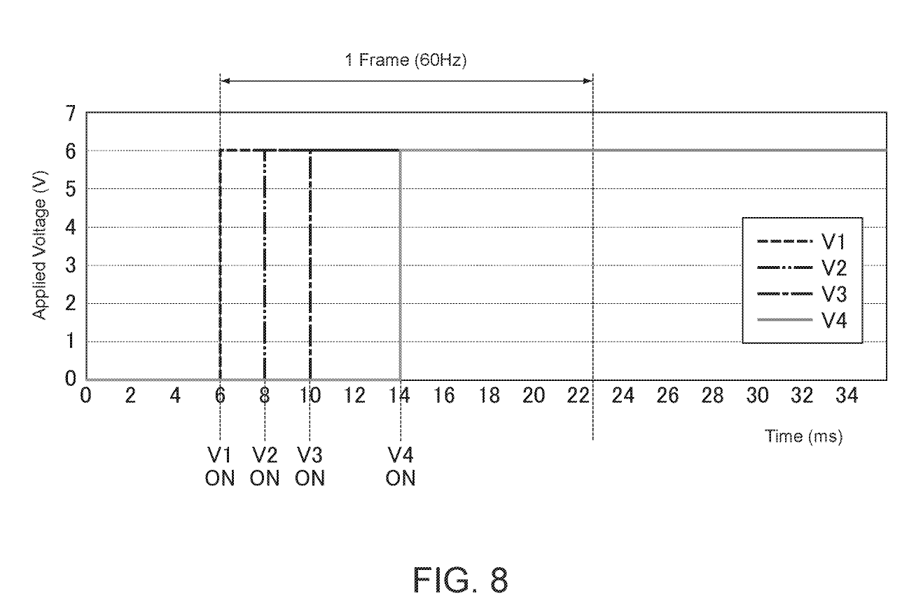

FIG. 8 shows a timing chart of signals applied to the pixel electrode in the respective working examples and comparative examples.

All of the pixel electrodes 17a, 17b, 17c, 37a, 37b, and 37c were set to be capable of being driven independently of one another. As shown in FIG. 8 and table 1 below, in the present working example the same signal V1 was applied to the respective pixel electrodes 17a, 17b, 17c, 37a, 37b, and 37c. In table 1 below, the pixel electrodes 17a, 17b, 17c, 37a, 37b, and 37c are denoted by A, B, C, D, E, and F, respectively. The signal V1 was kept low level (=0V) until after 6 ms, and from after 6 ms changed to high level (=6V). After 6 ms is the start of the frame (≈16.7 sm, 60 Hz). Furthermore, the low level (=0V) signal was continually applied to the first and second opposite electrodes 15 and 35.

TABLE 1

| | | Comparative | | | | | |
|---|---|---|---|---|---|---|---|
| | | Example 2 | | | | | |
| | Comparative | Only lower | Working | Working | Working | Working | Working |
| | Example 1 | substrate | Example | Example | Example | Example | Example |
| | FFS | driven | 1 | 2 | 3 | 4 | 5 |
| L/S | L/S = 3/3 | L/S = 3/3 | L/S = 3/3 | L/S = 3/3 | L/S = 3/3 | L/S = 3/3 | L/S = 3/4 |
| Cell | d = 3.2 | d = 3.2 | d = 3.2 | d = 3.2 | d = 3.2 | d = 3.2 | d = 3.2 |
| Thickness | | | | | | | |
| A | V1 | 0 | V1 | V1 | V1 | V1 | V1 |
| B | — | 0 | V1 | V2 | V3 | V2 | V3 |
| C | — | 0 | V1 | V1 | V1 | V3 | V4 |
| D | — | V1 | V1 | V1 | V1 | V1 | V1 |
| E | — | V2 | V1 | V2 | V3 | V2 | V3 |
| F | — | V1 | V1 | V1 | V1 | V3 | V4 |

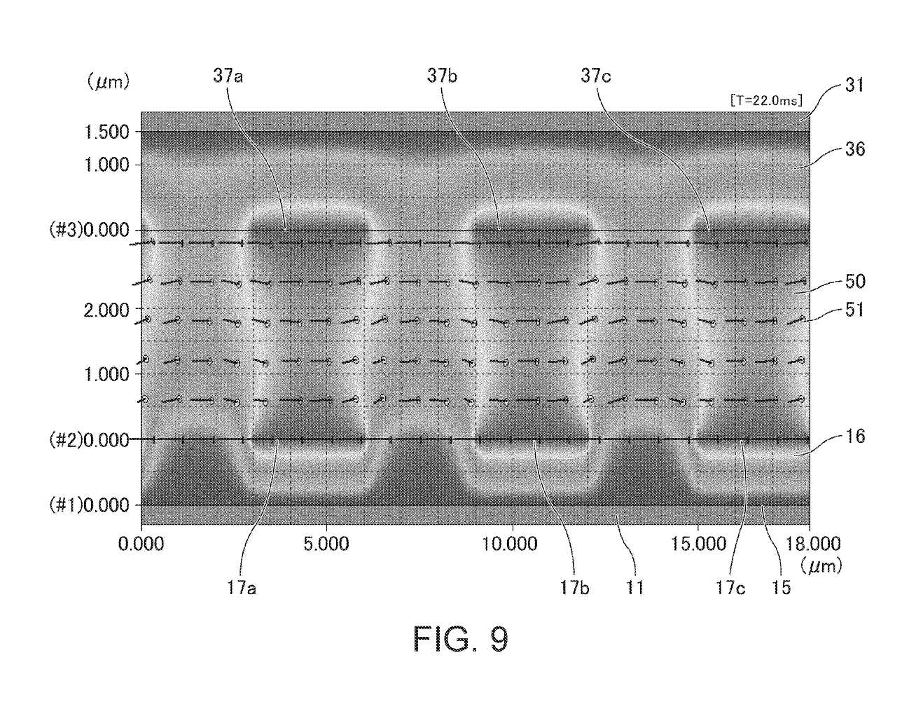

FIG. 9 shows electric field distribution and the liquid crystal director of Working Example 1 in the ON state.

As shown in FIG. 9, in the ON state it is possible to rotate the liquid crystal molecules 51 due to fringe fields being generated between the respective first pixel electrodes 17a, 17b, 17c and the first opposite electrode 15 in the layer therebelow, and between the respective second pixel electrodes 37a, 37b, 37c and the second opposite electrode 35 thereabove. When changing from the OFF state to ON state, the liquid crystal molecules 51 rotate away from the initial alignment direction, and photo-optical modulation occurs from black display (low gradation) to white display (high gradation). In order to more actively drive the liquid crystal molecules 51, it is preferable that the fringe fields be generated in the vicinity of the array substrate and opposite substrate, respectively, and that the fringe fields above and below these drive the liquid crystal molecules 51.

### Working Example 2

As shown in FIG. 8 and table 1, the present working example is the same as Working Example 1 except in that the same signal V2 was applied to the pixel electrode 17b and pixel electrode 37b.

The signal V2 was kept low level (=0V) until after 8 ms, and from after 8 ms changed to high level (=6V).

### Working Example 3

As shown in FIG. 8 and table 1, the present working example is the same as Working Example 1 except in that the same signal V3 was applied to the pixel electrode 17b and pixel electrode 37b.

The signal V3 was kept low level (=0V) until after 10 ms, and from after 10 ms changed to high level (=6V).

### Working Example 4

As shown in FIG. 8 and table 1, the present working example is the same as Working Example 1 except in that the same signal V2 was applied to the pixel electrode 17b and pixel electrode 37b and the same signal V3 was applied to the pixel electrode 17c and pixel electrode 37c.

### Working Example 5

As shown in FIG. 8 and table 1, the present working example is the same as Working Example 1 except in that the same signal V2 is applied to the pixel electrode 17b and pixel electrode 37b and the same signal V4 is applied to the pixel electrode 17c and pixel electrode 37c.

The signal V4 was kept low level (=0V) until after 14 ms, and from after 14 ms changed to high level (=6V).

### Comparative Example 1

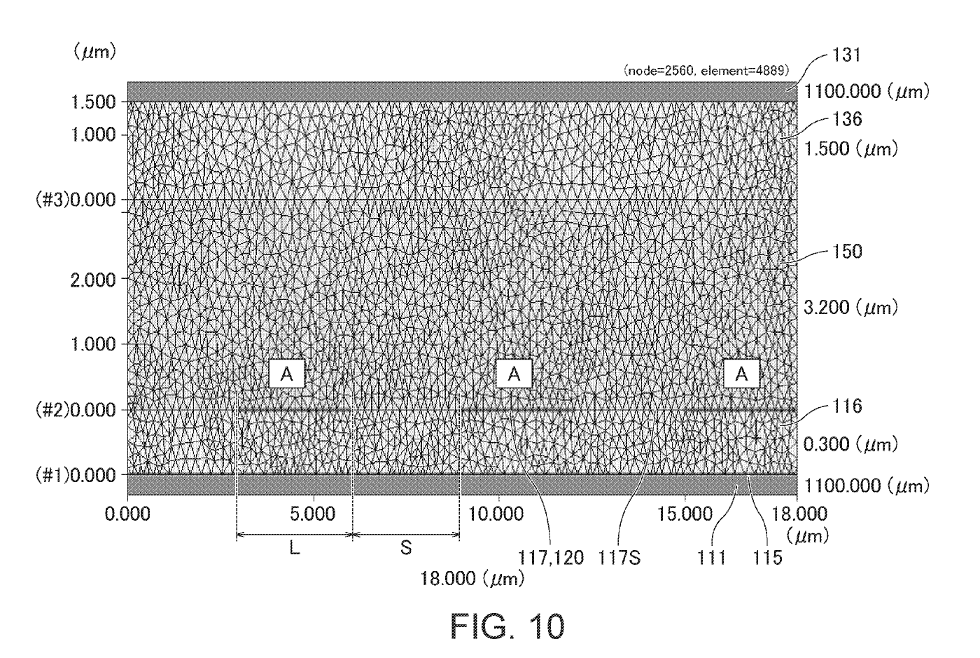

FIG. 10 is a schematic cross-sectional view of a model used in Comparative Example 1.

As shown in FIG. 10, the liquid crystal panel of the present comparative example is an FFS liquid crystal panel. The liquid crystal layer 150 was formed using negative-type liquid crystal with a birefringence Δn of 0.1, a dielectric anisotropy Δ∈ of −2.5, and a viscosity of 120 cP. The cell thickness was set to 3.2 μm and the panel retardation Re to 320 nm. The initial alignment of the liquid crystal liquid was set to a parallel alignment under the presumption of horizontal alignment films being arranged on the respective front surfaces of the array substrate and opposite substrate on the liquid crystal layer 150 side. The pixel electrode 117 and opposite 115 were arranged on the liquid crystal layer 150 side of the first insulating substrate 111 of the array substrate. The pixel electrode 117 was arranged in an upper layer and the opposite electrode 115 in a lower layer, and a first insulating layer 116 with a dielectric constant of 6.9 and a film thickness of 0.3 μm was disposed between the pixel electrode 117 and opposite electrode 115. The opposite electrode 115 was seamlessly disposed in a rectangular shape in the entire sub-pixel region. The pixel electrode 117 had three slits 117S formed therein extending in the vertical direction (the direction perpendicular to the sheet surface of FIG. 10, and four linear portions 120 of the pixel electrode 117 were arranged with gaps therebetween. A width L of the respective linear portions 120 was 3 μm for all of the linear portions, and gaps S between adjacent linear portions 120 (in other words, the width of the respective slits 117S) was 3 μm for each gap. A second insulating layer 136 with a dielectric constant of 3.4 and a film thickness of 1.5 μm was disposed on the liquid crystal layer 150 side of the second insulating substrate 131 of the opposite substrate. The angle formed by the initial alignment direction and the extension direction of the respective linear portions 120 was set to 97°. A pair of polarizing plates were disposed in a crossed Nicols state, with one transmission axis disposed parallel to the initial alignment direction and the other transmission axis disposed orthogonal to the initial alignment direction, the liquid crystal panel of the present comparative example being set to a normally black mode.

As shown in FIG. 8 and table 1, in the present comparative example, the signal V1 was applied to the pixel electrode 117 (the respective linear portions 120). In table 1, the pixel electrode 117 is labeled “A.”

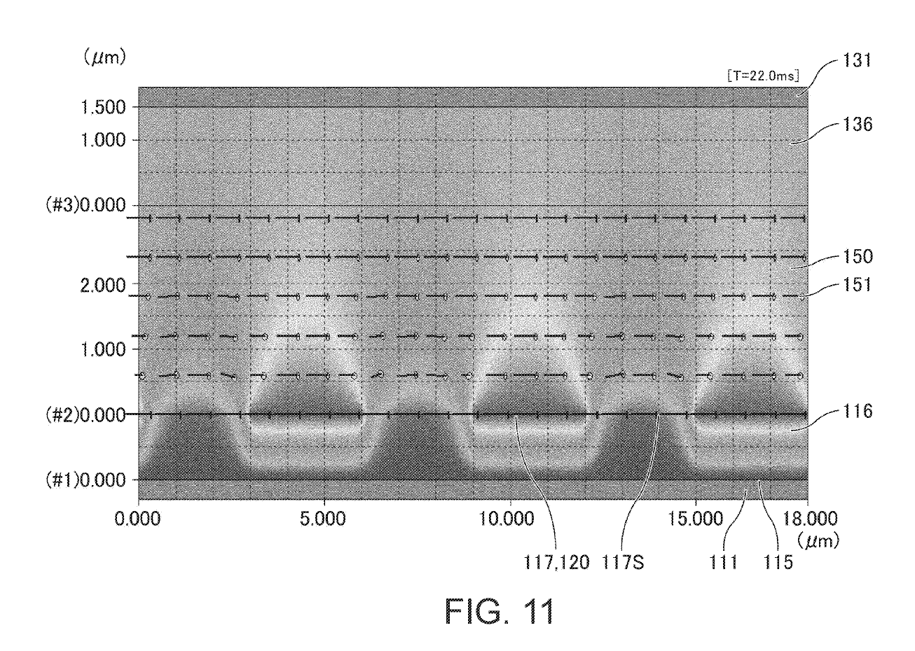

FIG. 11 shows electric field distribution and the liquid crystal director of Comparative Example 1 in the ON state.

As shown in FIG. 11, in the ON state, a fringe field is generated between the pixel electrode 117 and the opposite electrode 115 in a layer below the pixel electrode, which makes it possible to rotate the liquid crystal molecules 151. When changing from the OFF state to ON state, the liquid crystal molecules 151 rotate away from the initial alignment direction, and photo-optical modulation occurs from black display (low gradation) to white display (high gradation). In the present comparative example, it is possible to confirm that that the liquid crystal molecules 151 in the vicinity of the opposite substrate are not operating, unlike in Working Example 1.

### Comparative Example 2

As shown in FIG. 8 and table 1, the present comparative example is the same as Working Example 2 except in that the same low-level (=0V) signal was continually applied to the pixel electrodes 37a, 37b, and 37c of the opposite substrate.

In the present comparative example, only the first pixel electrodes 17a, 17b, and 17c of the array substrate were driven.

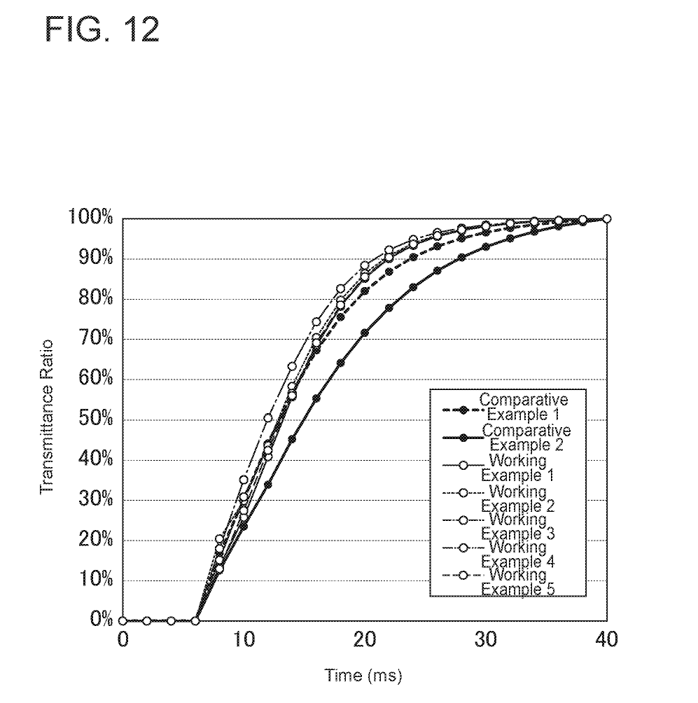

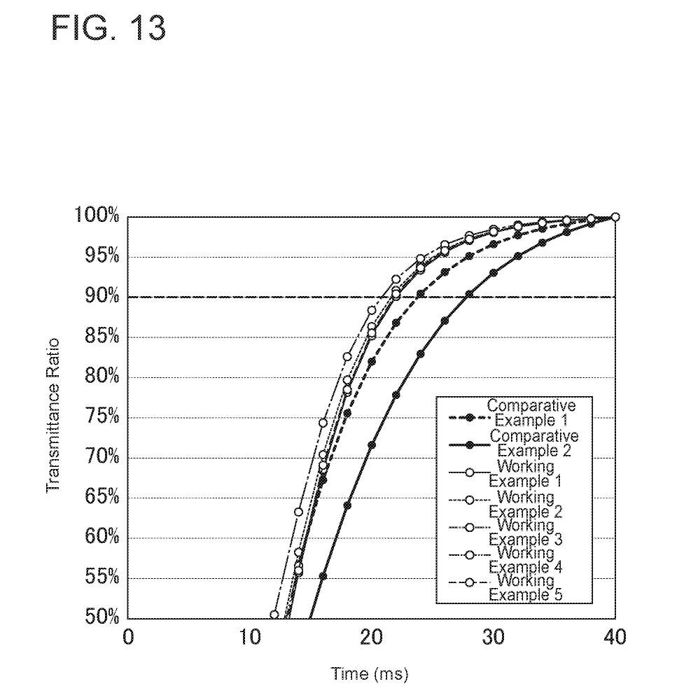

Next, the results of comparisons between the optical performance, or more specifically, the onset periods and maximum transmittance of Working Examples 1 to 5 and Comparative Examples 1 and 2 will be explained. FIGS. 12 and 13 are graphs that show changes in the transmittance ratios for Working Examples 1 to 5 and Comparative Examples 1 and 2, and FIG. 13 enlarges a portion of FIG. 12 in order to more clearly determine response characteristics during the onset period.

The onset period (onset response) is defined as the amount of time for the transmittance ratio, or in other words, the transmittance when the maximum transmittance is 100%, to change from 90% to 10%. In each example, driving was started at 6 ms. Table 2 below shows the onset periods and maximum transmittance for Working Examples 1 to 5 and Comparative Examples 1 and 2. The maximum transmittance is shown as a percentage of the maximum transmittance of Comparative Example 1.

TABLE 2

| | | Comparative | | | | | |
|---|---|---|---|---|---|---|---|
| | | Example 2 | | | | | |
| | | Only | | | | | |
| | Comparative | lower | Working | Working | Working | Working | Working |
| | Example 1 | substrate | Example | Example | Example | Example | Example |
| | FFS | driven | 1 | 2 | 3 | 4 | 5 |
| L/S | L/S = 3/3 | L/S = 3/3 | L/S = | L/S = | L/S = | L/S = | L/S = |
| | | | 3/3 | 3/3 | 3/3 | 3/3 | 3/4 |
| Cell | d = 3.2 | d = 3.2 | d = 3.2 | d = 3.2 | d = 3.2 | d = 3.2 | d = 3.2 |
| Thickness | | | | | | | |
| A | V1 | 0 | V1 | V1 | V1 | V1 | V1 |
| B | — | 0 | V1 | V2 | V3 | V2 | V3 |
| C | — | 0 | V1 | V1 | V1 | V3 | V4 |
| D | — | V1 | V1 | V1 | V1 | V1 | V1 |
| E | — | V2 | V1 | V2 | V3 | V2 | V3 |
| F | — | V1 | V1 | V1 | V1 | V3 | V4 |
| Response | 18 ms | 22 ms | 16 ms | 15.5 ms | 15 ms | 16 ms | 16 ms |
| (10-90%) | | | | | | | |
| Effect | — | x | ✓ | ✓~✓✓ | ✓✓ | ✓ | ✓ |
| Max. | 100% | 77% | 120% | 120% | 120% | 120% | 120% |
| Transmittance | | | | | | | |
| (REF rate) | | | | | | | |
| Effect | — | x | ✓ | ✓ | ✓ | ✓ | ✓ |

As shown in FIGS. 12 & 13 and Table 2, it was possible to confirm that Working Examples 1 to 5 had a shorter onset period and a faster response from OFF state to ON state than Comparative Example 1. It was further possible to confirm that Working Examples 1 to 5 are able to achieve a higher transmittance than Comparative Example 1. Actively operating the liquid crystal molecules by generating fringe fields in the vicinity of the array substrate and opposite substrate resulted in the capability to achieve higher speeds and higher transmittance.

Furthermore, as can be seen in Working Examples 2 and 3, the higher speed effects were improved by significantly delaying the timings for driving the pixel electrodes 17b and 37b, which were separated from the pixel electrodes 17a, 17c, 37a, and 37c by approximately the same distance as the cell thickness. In other words, it was confirmed that higher speed effects were improved by shifting the timing for driving the centrally-located pixel electrodes 17b and 37c away from the timing for driving the pixel electrodes 17a, 17c, 37a, and 37c located at the edges in consideration of the flow of liquid crystal molecules during initial operation.

Comparative Example 2 does not drive the electrodes of the opposite substrate, and thus liquid crystal molecule movement is poor, without prospects for higher speeds.

### DESCRIPTION OF REFERENCE CHARACTERS

1 liquid crystal panel
2 backlight unit
3 sub-pixel
10 array substrate
11 first insulating substrate
12 first gate bus line
12a, 12b gate bus line
13 first source bus line
13a, 13b, 13c source bus line
14 first thin film transistor (TFT)
14a, 14b, 14c thin film transistor (TFT)
15 first opposite electrode
16 first insulating layer
17 first pixel electrode
17a, 17b, 17c pixel electrode (first pixel electrode)
18 first horizontal alignment film
19a, 19b, 19c first contact hole
30 opposite substrate
31 second insulating substrate
32 second gate bus line
32a, 32b gate bus line

1: A liquid crystal display device, comprising:
a first substrate; a second substrate facing the first substrate; a horizontal orientation-type liquid crystal layer disposed between the first substrate and the second substrate and containing liquid crystal molecules; and pixels,
wherein the first substrate includes a first opposite electrode that is planar-shaped, a plurality of first pixel electrodes that are linear and disposed parallel to one another in each of the pixels, and a first insulating layer between the first opposite electrode and the plurality of first pixel electrodes,
wherein the second substrate includes a second opposite electrode that is planar-shaped facing the first opposite electrode, a plurality of second pixel electrodes provided corresponding to the plurality of first pixel electrodes in each of the pixels, and a second insulating layer between the second opposite electrode and the plurality of second pixel electrodes,
wherein the plurality of second pixel electrodes are respectively disposed in parallel to the corresponding first pixel electrodes, and
wherein an orientation of the liquid crystal molecules is changed by applying a voltage between the respective first pixel electrodes and the first opposite electrode and applying a voltage between the respective second pixel electrodes and the second opposite electrode.

2: The liquid crystal display device according to claim 1, wherein the liquid crystal molecules have a negative dielectric anisotropy.

3: The liquid crystal display device according to claim 1, wherein at least one of the plurality of first pixel electrodes, and the second pixel electrode corresponding thereto, are driven at a different timing than the other first and second pixel electrodes.

4: The liquid crystal display device according to claim 1,
wherein the plurality of first pixel electrodes are three first pixel electrodes that are adjacent to one another,
wherein the plurality of second pixel electrodes are three second pixel electrodes corresponding to the three first pixel electrodes, and
wherein, among the three first pixel electrodes, the first pixel electrode in the center, and the second pixel electrode corresponding thereto, are driven at a delayed timing compared to the other first and second pixel electrodes.

5: The liquid crystal display device according to claim 1,
wherein the first substrate includes, in each of the pixels, a plurality of first switching devices provided corresponding to the plurality of first pixel electrodes,
wherein the plurality of first switching devices respectively connect to the corresponding first pixel electrodes,
wherein the second substrate includes a plurality of second switching devices provided corresponding to the plurality of second pixel electrodes, and
wherein the plurality of second switching devices respectively connect to the corresponding second pixel electrodes.
